(19) United States
(12) Patent Application Publication
(10) Pub. No.: US 2012/0327283 A1
(43) Pub. Date: Dec. 27, 2012

(54) SOLID-STATE IMAGING DEVICE AND METHOD OF EVALUATING BLOOMING

(75) Inventors: Hidenobu KAWATA, Kanagawa (JP); Keiji ONOCHI, Kanagawa (JP); Kazumasa SANADA, Kanagawa (JP); Jun CHISHIKI, Kanagawa (JP)

(73) Assignee: Kabushiki Kaisha Toshiba, Tokyo (JP)

(21) Appl. No.: 13/423,629

(22) Filed: Mar. 19, 2012

(30) Foreign Application Priority Data
Jun. 27, 2011 (JP) 2011-141405

(51) Int. Cl. H04N 5/335

(52) U.S. Cl. 348/312; 348/E05.091

(57) ABSTRACT

An embodiment includes a pixel array unit in which pixels configured to accumulate charges generated by photoelectric conversion are arranged in matrix, a row scanning circuit that drives the pixels in units of a row, a charge injecting unit that injects charges into the pixels of a portion of the pixel array unit, and a timing control circuit that controls driving timing and charge injection timing of the pixels.

### CROSS-REFERENCE TO RELATED APPLICATIONS

This application is based upon and claims the benefit of priority from Japanese Patent Application No. 2011-141405, filed on Jun. 27, 2011; the entire contents of which are incorporated herein by reference.

### FIELD

Embodiments described herein relates generally to a solid-state imaging device and a method of evaluating blooming.

### BACKGROUND

In a CMOS image sensor, when high illuminance light is incident thereon, a large amount of charges are generated by a photodiode and the amount of the charges that exceeds the emission capacity overflows into surrounding pixels, which results in the blooming.

As a method of evaluating the blooming, there is a quantification method which causes the high illuminance light to be incident on all exposure pixels and detects the charges that overflows from the pixels using light-shielded pixels so as to quantify the amount of charges. In this method, when the assumed usage condition is the environment under fine weather in outdoor, a light source with the illuminance equal to sunlight is necessarily prepared.

### BRIEF DESCRIPTION OF THE DRAWINGS

FIG. 1 is block diagram illustrating a schematic configuration of a solid-state imaging device according to a first embodiment;

FIG. 2A is a circuit diagram illustrating a configuration of a pixel PC of FIG. 1 and FIG. 2B is a circuit diagram illustrating a configuration of a pixel PC′ of FIG. 1;

FIG. 3A is a cross-sectional view illustrating a relevant portion of the pixel PC of FIG. 2A, FIG. 3B is a potential chart illustrating a charge state when the pixel PC of FIG. 2A has a low illuminance, and FIG. 3C is a potential chart illustrating a charge state when the pixel PC of FIG. 2A has a high illuminance;

FIG. 4A is a cross-sectional view illustrating a relevant portion of the pixel PC′ of FIG. 2B and FIG. 4B is a potential chart illustrating a charge state when charges are injected into the pixel PC′ of FIG. 2A;

FIG. 5 is a plan view illustrating a state in which the charges of the pixel PC′ of FIG. 2A diffuses to surrounding pixels when the charges are injected into the pixel PC′; and

FIG. 6 is a flowchart illustrating a method of evaluating blooming in a solid-state imaging device according to a second embodiment.

### DETAILED DESCRIPTION

A solid-state imaging device according to an embodiment is provided with a pixel array unit, a row scanning circuit, a charge injecting unit, and a timing control circuit. In the pixel array unit, pixels configured to accumulate charges generated by photoelectric conversion are arranged in matrix. The row scanning circuit drives the pixels in units of a row. The charge injecting unit injects the charges into the pixels of a portion of the pixel array unit. The timing control circuit controls driving timing and charge injection timing of the pixels.

Hereafter, the solid-state imaging device according to the embodiment is described with reference to the drawings. The present invention is not limited to the embodiment.

### First Embodiment

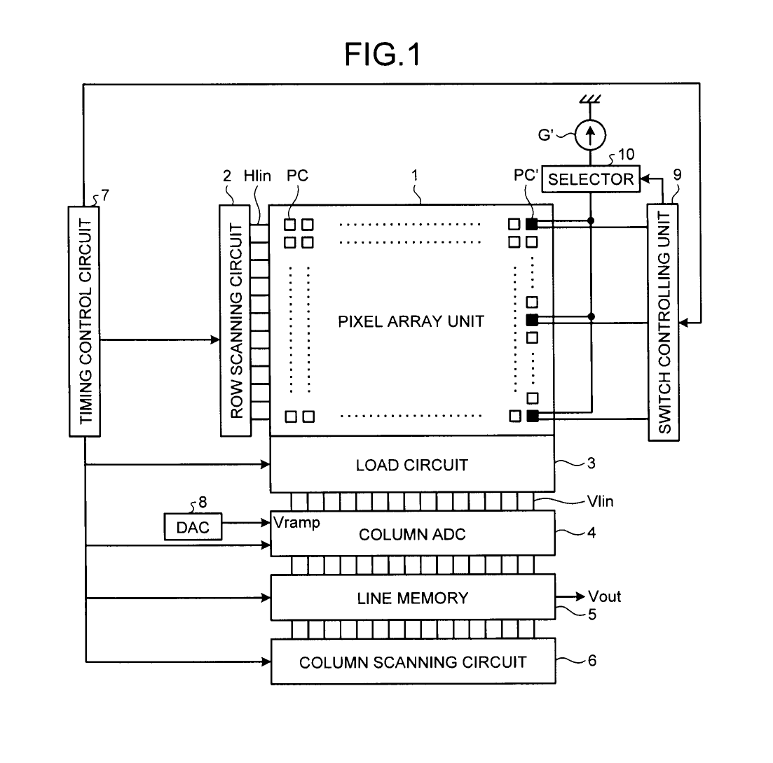

FIG. 1 is a block diagram illustrating a schematic configuration of a solid-state imaging device according to a first embodiment.

Referring to FIG. 1, the solid-state imaging device is provided with: a pixel array unit 1 in which pixels PC configured to accumulate charges generated by photoelectric conversion are arranged in matrix, in a direction of row and a direction of column; a row scanning circuit 2 that drives the pixels PC serving as reading targets in units of a row; a load circuit 3 that causes a potential of a vertical signal line Vlin to follow a signal read from the pixel; a column ADC circuit 4 that digitalizes a signal component of each of the pixels PC using a CDS, a line memory 5 that stores the signal components of the respective pixels PC of a row which have been digitalized by the column ADC circuit 4; a column scanning circuit 6 that scans the pixels PC serving as reading targets in a horizontal direction; a timing control circuit 7 that controls driving timing of the pixels PC and charge injection timing of the pixels PC′; a DA converter 8 that outputs a ramp signal Vramp to the column ADC circuit 4; a current supply G′ that injects charges to the pixels PC′ of a portion of the pixel array unit 1; a selector 10 that prevents the charges from being injected into the pixels PC′; and a switch controlling unit 9 that performs switching control such that the charges are injected into the pixels PC′. In addition, the pixels PC′ may be disposed at the edge of the pixel array unit 1. Because of the arrangement at the edge, wiring structure/layout of the pixel array unit 1 can be maintained as conventionally implemented except for the vicinity of the pixels PC′.

Here, in the pixel array unit 1, a horizontal control line Hlin is provided along the direction of row so as to control reading of the pixels PC and PC′ and a vertical signal line Vlin is provided along the direction of column so as to transfer signals read from the pixels PC and PC′.

During an imaging operation, the selector 10 is turned off by the switch controlling unit 9 so that the pixel PC′ and the current supply G′ are disconnected. Moreover, the pixels PC and PC′ are scanned in the vertical direction by the row scanning circuit 2 so that the pixels PC and PC′ in the direction of row are selected, and the signals read from the pixels PC and PC′ are transferred to the column ADC circuit 4 through the vertical signal line Vlin. Here, in the load circuit 3, a source follower circuit is formed between the pixels PC and PC′ at the time when the signals are read from the pixels PC and PC′, so that the potential of the vertical signal line Vlin may follow the signals read from the pixels PC and PC′.

In the column ADC circuit 4, a reset level and a reading level output from the pixels PC and PC′ are sampled, and a difference between the reset level and the reading level is acquired. In this way, a signal component of each of the pixels PC and PC′ is digitalized by the CDS and is then output as an output signal Vout through the line memory 5.

On the other hand, during a blooming evaluation operation, the selector 10 is turned on by the switch controlling unit 9 so that the pixel PC′ is connected with the current supply G′. Then, the current is injected from the current supply G′ into pixel PC′. This time, the amount of the current is set such that the charges can overflow from the pixel PC′ into surrounding pixels PC. At this time, the pixels PC and PC′ are scanned in the vertical direction by the row scanning circuit 2, and as a result the pixels PC and PC′ in the direction of row are selected and signals read from the pixels PC and PC′ are transferred to the column ADC circuit 4 through the vertical signal line Vlin.

In addition, in the column ADC circuit 4, the reset level and the reading level output from each of the pixels PC are sampled, and a difference between the reset level and the reading level is acquired. By this operation, a signal component of each of the pixels PC is digitalized by the CDS. Then, the signal component is output as an output signal Vout through the line memory 5. Therefore, referring to the image obtained at this time, the blooming can be evaluated by checking a range of surrounding pixels PC into which the charges from the pixel PC′ overflow. Thus, the pass or fail determination on the solid-state imaging device to be shipped can be made on the basis of the result of this blooming evaluation.

Here, because the charges can be injected into only the pixels PC′ corresponding to a portion of the pixel array unit 1, the blooming can be evaluated without entering light into the pixel array unit 1. Therefore, the usage condition, which is the environment under fine weather in outdoor, can be reproduced without preparing a light source having the illuminance equal to sunlight when the blooming is evaluated.

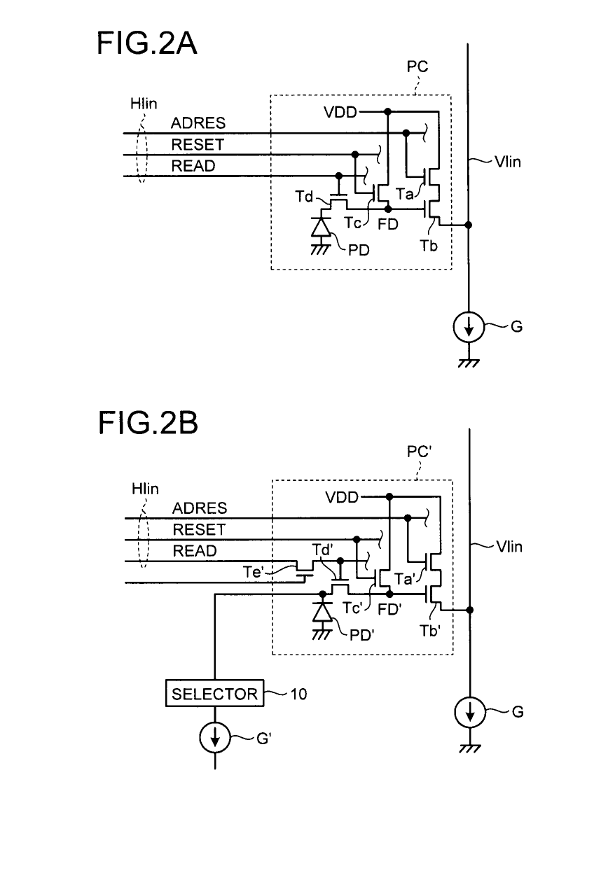

FIG. 2A is a circuit diagram illustrating a configuration of the pixel PC of FIG. 1 and FIG. 2B is a circuit diagram illustrating a configuration of the pixel PC′ of FIG. 1.

Referring to FIG. 2A, the Pixel PC includes a photodiode PD, a row selection transistor Ta, an amplification transistor Tb, a reset transistor Tc, and a reading transistor Td. Moreover, a floating diffusion FD as a detection node is formed in the connection point of the amplification transistor Tb, the reset transistor Tc, and the reading transistor Td.

The source of the reading transistor Td is connected with the photodiode PD, and a reading signal READ is input to the gate of the reading transistor Td. Moreover, the source of the reset transistor Tc is connected with the drain of the reading transistor Td, a reset signal RESET is input to the gate of reset transistor Tc, and the drain of reset transistor Tc is connected with a power supply potential VDD. Moreover, a row selection signal ADRES is input to the gate of the row selection transistor Ta, and the drain of the row selection transistor Ta is connected with the power supply potential VDD. Moreover, the source of the amplification transistor Tb is connected with the vertical signal line Vlin, the gate of the amplification transistor Tb is connected with the drain of the reading transistor Td, and the drain of the amplification transistor Tb is connected with the source of the row selection transistor Ta. Moreover, the current supply G is connected with the vertical signal line Vlin.

In addition, the horizontal control line Hlin in FIG. 1 can transfer the reading signal READ, the reset signal RESET, and the row selection signal ADRES to the pixels PC for each row.

The row selection transistor Ta enters an off state and thus the source follower circuit is not formed when the row selection signal ADRES is a low level. Accordingly, a signal is not output to the vertical signal line Vlin. At this time, if the reading signal READ and the reset signal RESET become a high level, the reading transistor Td is turned on and thus the charges that have been accumulated in the photodiode PD are discharged to the floating diffusion FD. In addition, the charges are discharged to the power supply VDD through the reset transistor Tc.

When the reading signal READ becomes the low level after the charges that have been accumulated in the photodiode PD are discharged to the power supply VDD, the accumulation of effective signal charges is begun in the photodiode PD.

Next, when the row selection signal ADRES becomes the high level, the source follower circuit is formed by the amplification transistor Tb and the load circuit 3 because the row selection transistor Ta of the pixel PC is turned on and hence the power supply potential VDD is supplied to the drain of amplification transistor Tb.

Next, when the reset signal RESET rises, the reset transistor Tc is turned on, so that the extra charges generated in the floating diffusion FD due to the leakage current or the like are reset. Then, the voltage corresponding to the reset level of the floating diffusion FD is applied to the gate of amplification transistor Tb. Here, since the amplification transistor Tb and the load circuit 3 forms a source follower circuit, the voltage of the vertical signal line Vlin follows the voltage applied to the gate of the amplification transistor Tb, and the output voltage Vsig with the reset level is output to the column ADC circuit 4 through the vertical signal line Vlin.

In addition, a triangular wave is supplied, as a ramp signal Vramp, to the column ADC circuit 4 with the output voltage Vsig of the reset level being input, and hence the output voltage Vsig of the reset level and the ramp signal Vramp are compared in column ADC circuit 4.

In addition, the output voltage Vsig of the reset level is converted into a digital value and kept in such a manner that a down count is performed until the output voltage Vsig of the reset level agrees with the level of the ramp signal Vramp.

Next, the reading transistor Td is turned on when the reading signal READ rises, the charges that have been accumulated in the photodiode PD are transmitted to the floating diffusion FD, and the voltage corresponding to the signal level of the floating diffusion FD is applied to the gate of the amplification transistor Tb. Here, since the source follower circuit is formed by the amplification transistor Tb and the load circuit 3, the voltage of the vertical signal line Vlin follows the voltage applied to the gate of the amplification transistor Tb, and the output voltage Vsig of the reading level is output to the column ADC circuit 4 through the vertical signal line Vlin.

In addition, a triangular wave is input, as the ramp signal Vramp, to the column ADC circuit 4 with the output voltage Vsig of the reading level being input, and the output voltage Vsig of the reading level and the ramp signal Vramp are compared in the column ADC circuit 4.

In addition, at this time the difference between the output voltage Vsig of the reading level and the output voltage Vsig of the reset level is converted into a digital value in such a manner that an up count is performed until the output voltage Vsig of the reading level agrees with the level of the ramp signal Vramp, and the digitalized value is sent to the line memory 5.

FIG. 2B is a circuit diagram illustrating a configuration of the pixel PC′ of FIG. 1.

Referring to FIG. 2B, the pixel PC′ includes a photodiode PD′, a row selection transistor Ta′, an amplification transistor Tb′, a reset transistor Tc′, a reading transistor Td′, and a select transistor Te′. Moreover, a floating diffusion FD′ is formed as a detection node in the connection point of the amplification transistor Tb′, the reset transistor Tc′, and the reading transistor Td′.

Moreover, the source of the reading transistor Td′ is connected with the photodiode PD′, and the gate of the reading transistor Td′ is connected with the source of the select transistor Te′. Moreover, the source of the reset transistor Tc′ is connected with the drain of the reading transistor Td′, a reset signal RESET is input to the gate of the reset transistor Tc′, and the drain of the reset transistor Tc′ is connected with a power supply potential VDD. Moreover, the row selection signal ADRES is input to the gate of the row selection transistor Ta′, and the drain of the row selection transistor Ta′ is connected with the power supply potential VDD. Moreover, the source of the amplification transistor Tb′ is connected with the vertical signal line Vlin, the gate of the amplification transistor Tb′ is connected with the drain of the reading transistor Td′, and the drain of the amplification transistor Tb′ is connected with the source of the row selection transistor Ta′. The gate of the select transistor Te′ is connected with the switch controlling unit 9 illustrated in FIG. 1, and the reading signal READ is input to the drain of the select transistor Te′.

During the blooming evaluation operation, the selector 10 is turned on by the switch controlling unit 9 so that the pixel PC′ is connected with the current supply G′. Moreover, the select transistor Te′ is turned off by the switch controlling unit 9 so that the reading signal READ to be input to the gate of the reading transistor Td′ is intercepted.

Moreover, the current is injected from the current supply G′ into the photodiode PD′, and the amount of the injected current is set such that the charges can overflow from the pixel PC′ into surrounding pixels PC. At this time, the pixels PC and PC′ are scanned in the vertical direction by the row scanning circuit 2 so that the pixels PC and PC′ in the direction of row are selected. Then, the signals read from the pixels PC and PC′ are transferred to the column ADC circuit 4 through the vertical signal line Vlin.

Moreover, in the column ADC circuit 4, a reset level and a reading level are sampled from the signal of each of the pixels PC and the difference between the reset level and the reading level is acquired. In this way, a signal component of each of the pixels PC is digitalized by the CDS and is output as an output signal Vout through the line memory 5. An amount of the charges that overflow from the pixel PC′ into the surrounding pixel PC can be quantitatively evaluated on the basis of the output signal Vout.

Here, during the blooming evaluation operation, the charges injected from the current supply G′ into photodiode PD′ can be prevented from being discharged to the floating diffusion FD′ through the reading transistor Td′, by intercepting the reading signal READ input to the gate of the reading transistor Td′. Therefore, the charges injected from the current supply G′ into the photodiode PD′ can be prevented from becoming useless, and as a result an injection efficiency of the charge supplied from the current supply G′ to photodiode PD′ can be improved.

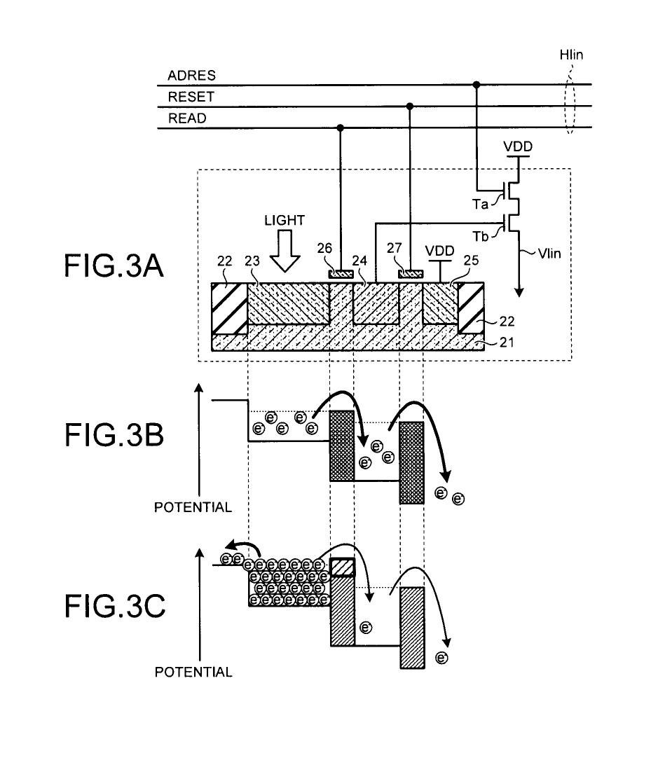

FIG. 3A is a cross-sectional view illustrating a relevant portion of the pixel PC of FIG. 2A, FIG. 3B is a potential chart illustrating a charge state when the pixel PC of FIG. 2A has a low illuminance, and FIG. 3C is a potential chart illustrating a charge state when the pixel PC of FIG. 2A has a high illuminance.

Referring to FIG. 3A, a well 21 is formed in a semiconductor substrate. Element isolating areas 22 are formed in the well 21 so that the well 21 is divided to correspond to each of the pixels PC by the element isolating areas 22. Moreover, impurity diffusion layers 23 to 25 separated from each other are formed in the well 21, a gate electrode 26 is formed on a channel area between the impurity diffusion layers 23 and 24 while having a gate insulation film formed therebetween, and a gate electrode 27 is formed on a channel area between the impurity diffusion layers 24 and 25 while having a gate insulation film formed therebetween.

In addition, the photodiode PD of FIG. 2A and the source of the reading transistor Td may be provided in the impurity diffusion layer 23. The drain of the reading transistor Td, the source of the reset transistor Tc, and the floating diffusions FD of FIG. 2A may be provided in the impurity diffusion layer 24. The drain of the reset transistor Tc of FIG. 2A can be provided in the impurity diffusion layer 25. The gate electrode 26 may serve the gate of the reading transistor Td of FIG. 2A. The gate electrode 27 may serve as the gate of the reset transistor Tc of FIG. 2A.

For low illuminance, the charge e⁻ generated by photoelectric conversion executed by the photodiode PD is accumulated in the photodiode PD. Subsequently, when the reading transistor Td is turned on, the charge e⁻ of the photodiode PD is discharged to the floating diffusion FD. Moreover, when the reset transistor Tc is turned on, the floating diffusion FD is discharged to the power supply potential VDD.

On the other hand, for high illuminance, the charge e⁻ generated by the photoelectric conversion executed by the photodiode PD is accumulated in the photodiode PD. Then, the charge e⁻ of the photodiode PD overflows into the floating diffusion FD even though the reading transistor Td is turned off. Moreover, the charge e⁻ of the photodiode PD of the pixel PC overflows into the surrounding pixel PC when the potential barrier of the element isolating area 22 is lower than the potential barrier of the reading transistor Td being in OFF state.

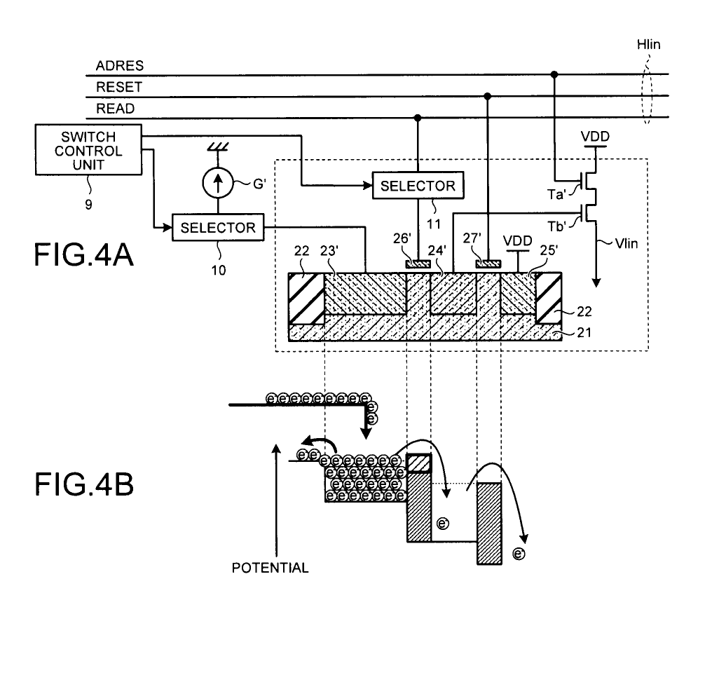

FIG. 4A is a cross-sectional view illustrating a relevant portion of the pixel PC′ of FIG. 2B, and FIG. 4B is a potential chart illustrating a charge state when charges are injected into the pixel PC′ of FIG. 2A.

Referring to FIG. 4A, the well 21 is formed in a semiconductor substrate. Element isolating areas 22 are formed in the well 21 so that the well 21 is divided to correspond to each of the pixels PC′ by the element isolating areas 22. Moreover, impurity diffusion layers 23′ to 25′ separated from each other are formed in the well 21, a gate electrode 26′ is formed on a channel area between the impurity diffusion layers 23′ and 24′ with a gate insulation film formed therebetween, and a gate electrode 27′ is formed on a channel area between the impurity diffusion layer 24′ and 25′ with a gate insulation film formed therebetween.

The photodiode PD′ and the source of the reading transistor Td′ of FIG. 2B may be provided in the impurity diffusion layer 23′. The drain of the reading transistor Td′, the source of the reset transistor Tc′, and the floating diffusions FD′ of FIG. 2B may be provided in the impurity diffusion layer 24′. The drain of the reset transistor Tc′ of FIG. 2B may be provided in the impurity diffusion layer 25′. The gate electrode 26′ may serve as the gate of the reading transistor Td′ of FIG. 2B. The gate electrode 27′ may serve as the gate of the reset transistor Tc′ of FIG. 2B.

Moreover, the selector 11, which prevents the charge e⁻ accumulated in the pixel PC′ from being read, is provided in the pixel PC′. Here, the reading signal READ is supplied to the gate electrode 26′ through the selector 11. This selector 11 may be configured by a select transistor Te′ of FIG. 2B.

During a charge injection operation, the selector 11 may intercept the reading signal READ being applied to the gate electrode 26′ so that the reading transistor Td′ is turned off. Moreover the selector 10 may allow the current supply G′ to be connected with the impurity diffusion layer 23′ so that the current is injected from the current supply G′ into the photodiode PD′. This time, the amount of the current is set such that the charge e⁻ overflows from the pixel PC′ into the surrounding pixel PC.

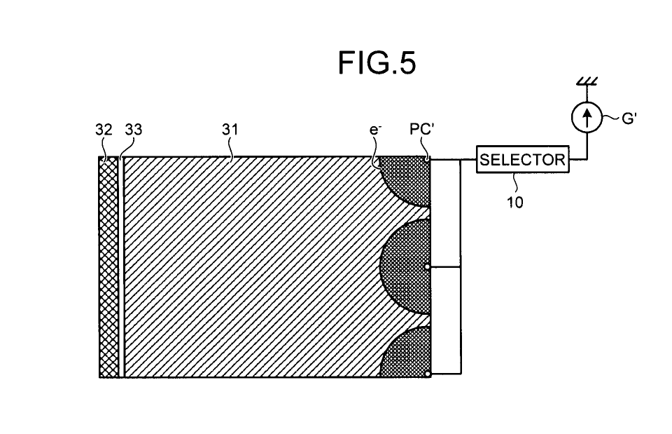

FIG. 5 is a plan view illustrating a state of charges being diffused to surrounding pixel when charges are injected to the pixel PC′ of FIG. 2A.

Referring to FIG. 5, an exposure pixel area 31 and an Optical Black (OB) pixel area 32 are provided in the pixel array unit 1 of FIG. 1. Moreover, a barrier area 33, which prevents the charge e⁻ overflowing from the exposure pixel area 31 from invading the OB pixel area 32, is formed between the exposure pixel area 31 and the OB pixel area 32.

In the exposure pixel area 31, the pixel PC′ is adjacent to the exposure pixel and is arranged at the edge of the exposure pixel area 31. The charge e⁻ overflows from the pixel PC′ into the surrounding pixel PC when the current is injected from the current supply G′ into the pixel PC′. The blooming can be evaluated by driving the pixel PC of the pixel array unit 1 under such a condition and by reading the signal from the pixel PC.

### Second Embodiment

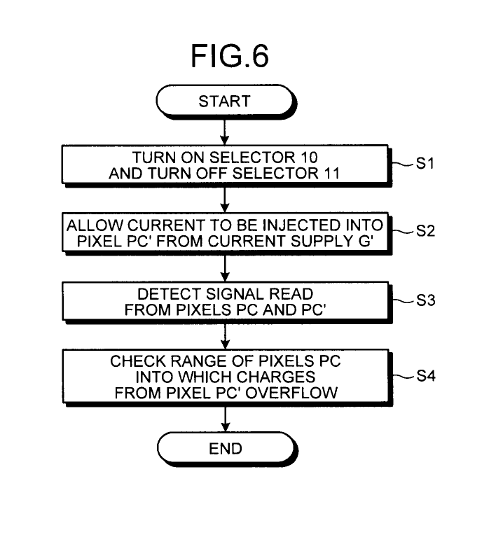

FIG. 6 is a flowchart illustrating a method of evaluating blooming in a solid-state imaging device according to a second embodiment.

In FIG. 6, at the time of evaluating blooming in a solid-stage imaging device, the selector 10 of FIG. 4 is turned on and the selector 11 is turned off in Step S1.

Next, current is injected into the pixel PC′ from the current supply G′ in Step S2, and at this time signals read from the pixels PC′ and PC are detected by the column ADC circuit 4 in Step S3. Subsequently, referring to an image obtained at this time, the blooming is evaluated by checking a range of the surrounding pixels PC into which the charges from the pixel PC′ overflow in Step S4.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device, comprising:
a pixel array unit in which pixels configured to accumulate charges generated by photoelectric conversion are arranged in matrix;
a row scanning circuit that drives the pixels in units of a row;
a charge injecting unit that injects charges into the pixels of a portion of the pixel array unit; and
a timing control circuit that controls driving timing and charge injection timing of the pixels.

2. The solid-state imaging device according to claim 1, wherein the pixel into which the charges are injected from the charge injecting unit are arranged at an end portion of the pixel array unit.

3. The solid-state imaging device according to claim 1, wherein the pixel into which the charges are injected from the charge injecting unit are arranged adjacent to an exposure pixel of the pixel array unit.

4. The solid-state imaging device according to claim 1, further comprising a first selector that prevents the charges from being injected into the pixel from the charge injecting unit.

5. The solid-state imaging device according to claim 4, further comprising a second selector provided in the pixel into which the charges are injected from the charge injecting unit, and configured to prevent the charges accumulated in the pixel from being read.

6. The solid-state imaging device according to claim 5, further comprising a switch controlling unit that performs switching control on injection of the charges into the pixel.

7. The solid-state imaging device according to claim 6, wherein the switch controlling unit prevents the charges from being injected into the pixel from the charge injecting unit by turning off the first selector during an imaging operation, and enables the charges to be injected into the pixel from the charge injecting unit by turning on the first selector during a blooming evaluation operation.

8. The solid-state imaging device according to claim 7, wherein the switch controlling unit enables the charges accumulated in the pixel to be read by turning on the second selector during the imaging operation, and prevents the charges accumulated in the pixel from being read by turning off the second selector during the blooming evaluation operation.

9. The solid-state imaging device according to claim 6, wherein the pixel includes:
a photodiode that executes photoelectric conversion;
a row selecting transistor that selects a row of the pixels;
a reading transistor that transmits a signal from the photodiode to a floating diffusion;
a reset transistor that resets a signal accumulated in the floating diffusion; and
an amplification transistor that detects a potential of the floating diffusion.

10. The solid-state imaging device according to claim 9, wherein the pixel into which the charges are injected from the charge injecting unit further includes a select transistor that prevents a reading signal from being input to a gate of the reading transistor.

11. The solid-state imaging device according to claim 10, wherein the photodiode is connected with a current supply through the first selector.

12. The solid-state imaging device according to claim 11, wherein the pixel array unit includes:
a horizontal control line that controls reading of the pixels in a direction of row; and
a vertical signal line that transfers a signal read from the pixel in a direction of column.

13. The solid-state imaging device according to claim 12, further comprising:
a load circuit that makes a potential of the vertical signal line follow the signal read from the pixel;
a column ADC circuit that digitalizes a signal component of the pixel with a CDS; and
a column scanning circuit that scans the pixel to be read in a horizontal direction.

14. The solid-state imaging device according to claim 13, wherein during the blooming evaluation operation, an amount of a current of the current supply is set such that the charges overflow from the pixel, into which the charges are injected from the charge injecting unit, to surrounding pixels,
wherein during the blooming evaluation operation, the first selector is turned on by the switch controlling unit so that the pixel is connected with the current supply,
wherein during the blooming evaluation operation, the pixels are scanned in a vertical direction by the row scanning circuit so that the pixels in the direction of row are selected, and a signal read from the pixel is transferred to the column ADC circuit through the vertical signal line,
and wherein during the blooming evaluation operation, the column ADC circuit digitalizes a signal component of the pixel using the CDS by sampling a reset level and a reading level from the signal of the pixel and acquiring a difference between the reset level and the reading level.

15. The solid-state imaging device according to claim 17, wherein during the imaging operation, the first selector is turned off by the switch controlling unit so that the pixel and the current supply are disconnected,
wherein during the imaging operation, the pixels are scanned by the row scanning circuit in the vertical direction so that the pixels in the direction of row are selected, and a signal read from the pixel is transferred to the column ADC circuit through the vertical signal line,
and wherein during the imaging operation, the column ADC circuit digitalizes a signal component of the pixel using the CDS by sampling a reset level and a reading level from the signal of the pixel and acquiring a difference between the reset level and the reading level.

16. A method of evaluating blooming, comprising:
injecting charges into a pixel of a portion of a pixel array unit in which pixels configured to accumulate charges generated by photoelectric conversion are arranged in matrix; and
reading a signal from the surrounding pixels when charges are injected into the pixel.

17. The method of evaluating blooming according to claim 16, wherein an injection amount of the charges is set such that the charges overflow from the pixel into which the charges are injected into the surrounding pixels.

18. The method of evaluating blooming according to claim 16, wherein pixels in a direction of row are selected in a manner that the pixels are scanned in a vertical direction, and a signal read from the pixel is transferred in a direction of column.

19. The method of evaluating blooming according to claim 18, wherein a signal component of the pixel is digitalized by a CDS in such a manner that a reset level and a reading level are sampled from a signal of the pixel and a difference between the reset level and the reading level is acquired.

20. The method of evaluating blooming according to claim 16, wherein during an imaging operation, charges being injected into the pixel are intercepted.
